(19) United States
(12) Patent Application Publication
(10) Pub. No.: US 2009/0179879 A1
(43) Pub. Date: Jul. 16, 2009

(54) DISPLAY DEVICE, METHOD OF DRIVING DISPLAY DEVICE, AND ELECTRONIC APPARATUS

(75) Inventor: Ryoichi NOZAWA, Tatsuno-machi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/351,074

(22) Filed: Jan. 9, 2009

(30) Foreign Application Priority Data
Jan. 10, 2008 (JP) 2008-002771
Sep. 25, 2008 (JP) 2008-246234

(51) Int. Cl. G09G 5/00

(52) U.S. Cl. 345/204

(57) ABSTRACT

A display device including a plurality of scan lines extending in a first direction, a plurality of signal lines extending in a second direction intersecting the first direction, and an element unit including a plurality of element rows arranged in parallel with the second direction which include a plurality of display elements corresponding to the plurality of signal lines. Each of the plurality of element rows includes a plurality of first display elements and a plurality of second display elements which emit display light in different directions. The plurality of scan lines include a plurality of first scan lines connected to at least two first display elements of to at least two element rows which correspond to separate signal lines, and a plurality of second scan lines connected to at least two second display elements of at least two element rows which correspond to separate signal lines.

### BACKGROUND OF THE INVENTION

The entire disclosures of Japanese Patent Application Nos. 2008-002771, filed Jan. 10, 2008 and 2008-246234, filed Sep. 25, 2008 are expressly incorporated herein by reference.

1. Technical Field

The present invention relates to image displays. More specifically, the present invention relates to image displays which are capable of displaying images in a plurality of directions.

2. Related Art

Various technologies capable of displaying images (hereinafter, conveniently referred to as a “first image” and a “second image”) in a plurality of directions are known in the art. For example, three-dimensional technologies are currently known wherein a first image and a second image having mutual parallax are output in different directions to the right and left eyes so as to allow a viewer to perceive the stereoscopic effect. In addition, there are also technologies known in the art for allowing viewers located in different positions with respect to a display device to view different images, such as, for example, car navigation devices which allow a viewer located at a right side of a display surface to view a first image, while allowing a viewer located at the left side of the display surface to view a second image. In a display device described in Japanese Patent No. 3096613, pixels for displaying the first image to the right eye and pixels for displaying the second image to the left eye are arranged in an alternating pattern in the vertical and horizontal direction. The display light of the pixels for the right eye and the display light of the pixels for the left eye are split by an optical body, in which openings and light-shielding portions are arranged in the vertical and horizontal direction so as to correspond to the pixels. Thus, the display light is emitted in different directions.

One problem with this configuration, however, is that the display element of the first image and a display element of the second image are connected to a common scan line and are arranged in alternating configuration in the horizontal direction, the signals of the pixels of the first and second image need to be supplied to a plurality of pixels of a selected row at the same time when each scan line is selected. Accordingly, a process or circuit for synthesizing the first image and the second image may become complicated.

### BRIEF SUMMARY OF THE INVENTION

An advantage of some aspects of the invention is that a configuration or method for displaying a plurality of images in different directions is simplified.

One aspect of the invention is a display device comprising a plurality of scan lines extending in a first direction, a plurality of signal lines extending in a second direction which intersects first direction, and an element unit including a plurality of element rows comprised of a plurality of display elements corresponding to the plurality of scan lines extending in the first direction, the plurality of element rows being arranged parallel to the second direction. Each of the plurality of element rows includes a plurality of first display elements and a plurality of second display elements which emit display light in different directions, and the plurality of scan lines include a plurality of first scan lines which are connected to at least two first display elements of at least two element rows which correspond to separate signal lines and a plurality of second scan lines which are connected to at least two second display elements of at least two element rows which correspond to separate signal lines.

Using this configuration, only the first display elements of the plurality of display elements are connected to the first scan lines and only the second display elements of the plurality of display elements are connected to the second scan lines, and the signals supplied to the signal lines are generated from a common image at the time when the first scan lines and the second scan lines are driven. Accordingly, a separate process or circuit for synthesizing the image displayed by the first display elements and the image displayed by the second display elements is unnecessary.

In the invention, the first display elements and the second display elements may be arranged in an alternating configuration in the first direction and the second direction, a light separating body in which openings and light-shielding portions are arranged in an alternating configuration in the first direction and the second direction may also be included, and the display light of the first display elements passing through the openings of the light separating body and the display light of the second display elements passing through the openings of the light separating body may travel in different directions. In this configuration, the display light of the first display elements and the display light of the second display elements can be consistently divided into equal amounts in the different directions. In addition, the display light of the first display elements may include both the emitted light from the first display elements and the irradiated light from an illumination device. Accordingly, the light separating body may be arranged at either the viewing side (front side) of the element unit or the rear side, being formed in the gap between the element unit and the illumination device. The same is true in the display light of the second display elements.

In the invention, the voltages applied to the plurality of display elements may be set such that the polarities of display elements have opposite polarities than the adjacent display elements. Using this configuration, since the display elements are divided between display elements with a positive polarity and display elements with a negative polarity, when the gradations of the display elements are changed according to the polarities of the applied voltages, the gradation of the image can remain uniform. Since the polarities of the applied voltages are reversed in the unit of the first display elements and the second display elements which are adjacent in the second direction, power consumption of the driving circuit is reduced when compared to a configuration in which the applied voltages of all the display elements adjacent in the second direction have opposite polarities.

Herein, applied voltages of “opposite polarities” indicate potentials supplied to the electrodes which are separately formed in the display elements, where one display element has a positive potential and the other display element has a negative potential based on a predetermined potential, such as, for example, the potential of a common electrode in the plurality of display elements. Applied voltages of the “same polarity” indicate potentials supplied to electrodes of the display elements, where both display elements have the same polarity.

In the invention, the applied voltages of the plurality of display elements are set such that the applied voltages of the plurality of display elements have opposite polarities than the adjacent display elements of the adjacent signal lines connected to the same scan line and opposite polarities than adjacent display elements in the second direction. Using this configuration, since an image is comprised of display elements of both positive and negative polarity, the gradation of the image can become uniform. Moreover, since the applied voltages of the plurality of first display elements (or the plurality of second display elements) are reversed in adjacent rows, gradation can be made more uniform. Furthermore, since the applied voltages of the first display elements and adjacent second display elements in the first direction have the same polarity, a phenomenon referred to as crosstalk in the first direction, wherein the applied voltages of the display elements have an influence on the applied voltages of adjacent display elements in the first direction may be suppressed.

In the invention, the applied voltages of the plurality of display elements may be set such that the polarities of the display elements have opposite polarities than display elements of adjacent signal lines and the same polarity than the first display elements and the second display elements which are adjacent in the second direction. Using this configuration, since the image comprises display elements of opposite polarities, the gradation of the image can become uniform. Since the applied voltages of the plurality of first display elements (or the plurality of second display elements) alternate in each row, the gradation of the image may be more uniform. Since the applied voltages of the first display elements and the second display elements which are adjacent in the second direction have the same polarity, the phenomenon of crosstalk of the second direction, wherein the applied voltages of the display elements have an influence on the applied voltages of adjacent display elements in the second direction may be suppressed.

In the invention, each of the plurality of display elements may correspond to any one of a plurality of display colors, and the applied voltages of the plurality of display elements may be set such that the polarities of display elements in each element group corresponding to the display colors have the same polarity, while the polarity of the display elements in adjacent element groups in the first and second direction are reversed. Using this configuration, since the applied voltages of the display elements in the same element group have the same polarity, the relationship between the gradations of the display colors may be more accurately set. Since an image comprises element groups of both positive and negative polarities, the gradation of the image can become more unified. Furthermore, since the polarities of the applied voltages are reversed in the unit of the first display elements and the second display elements which are adjacent in the second direction, power consumption of the driving circuit is reduced compared with the configuration in which the applied voltages of all the display elements adjacent in the second direction have the same polarities.

In the invention, the driving circuit may include a scan line driving circuit which is capable of alternately selecting the plurality of first scan lines and the plurality of second scan lines in the order of the second direction in every selection period; and a signal line driving circuit which outputs data voltages for specifying the applied voltages of the display elements to the signal lines in every selection period. Using this configuration, since the first scan lines and the second scan lines are sequentially selected, the configuration of the scan line driving circuit is simplified.

In the invention, the driving circuit may include a scan line driving circuit which sequentially selects the plurality of first scan lines in a selection period of a first period and sequentially selects the plurality of second scan lines in a selection period of a second period after the first period has ended; and a signal line driving circuit which outputs data voltages specifying the applied voltages of the display elements sent to the signal lines in every selection period. Using this configuration, since the plurality of first scan lines are sequentially selected in the first period and the plurality of second scan lines are sequentially selected in the second period, the period or the number of times of that the applied voltages of the display elements are separately set in the first display elements and the second display elements can be reduced.

In the invention, each of the plurality of display elements may correspond to any one of a plurality of display colors. Furthermore, the driving circuit may include a scan line driving circuit which sequentially selects the plurality of scan lines and a signal line driving circuit may output data voltages for specifying the applied voltages of the display elements to the signal lines in every selection period. The signal line driving circuit may include a plurality of distribution circuits corresponding to element groups arranged in the first direction, and the distribution circuits corresponding to the element groups may distribute an original signal for specifying the applied voltages of the plurality of display elements in the element groups in time division to a plurality of systems so as to generate the data voltages. Using this configuration, since the applied voltages of the display elements in the same element group have the same polarity, the original signal is maintained at the same polarity during the distribution of the original signal by the distribution circuit. Accordingly, the power consumption of the signal line driving circuit can be reduced as compared with the configuration in which the polarities of the applied voltages of the display elements in the element group are different.

An electronic apparatus of the invention includes the display device. Another aspect of the invention includes a method of driving the display device, which achieves the same operation and effect as the display device of previously described.

### BRIEF DESCRIPTION OF THE DRAWINGS

The invention will be described with reference to the accompanying drawings, wherein like numbers reference like elements.

FIG. 1 is a schematic view of a display device according to a first embodiment of the invention;

FIG. 2 is block diagram showing the electrical configuration of the display device of FIG. 1;

FIG. 3 is a conceptual diagram explaining the operation of a light separating body;

FIG. 4 is a timing chart showing the operation of the display device of FIG. 1;

FIGS. 5A and 5B are schematic views showing the contents of the display of an element unit in a unit period;

FIGS. 6A and 6B are schematic views of images viewed by a left eye and right eye of the viewer, respectively;

FIG. 7 is a timing chart showing the operation of a display device according to a second embodiment of the invention;

FIGS. 8A and 8B are schematic views showing the contents of a display according to a third embodiment of the invention;

FIGS. 9A and 9B are schematic views of images which may be viewed by a left and right eye of a viewer, respectively, according to the third embodiment of the invention;

FIGS. 10A and 10B are schematic views showing the contents of a display according to a fourth embodiment of the invention;

FIGS. 11A and 11B are schematic views of an image which may be viewed by a left and right eye of a viewer, respectively, according to the fourth embodiment of the invention;

FIG. 12 is a block diagram showing the electrical configuration of a display device according to a fifth embodiment of the invention;

FIG. 13 is a circuit diagram showing the configuration of a distribution circuit;

FIG. 14 is a timing chart showing the operation of the display device;

FIGS. 15A and 15B are schematic views showing the contents of the display of an element unit in a unit period;

FIGS. 16A and 16B are schematic views of an image which may be viewed by the left and right eye of a viewer, respectively;

FIG. 17 is a timing chart showing the operation of a display device according to a sixth embodiment of the invention;

FIG. 18 is a block diagram showing the electrical configuration of a display device according to a modified example;

FIG. 19 is a perspective view showing an example of an electronic apparatus comprising a personal computer;

FIG. 20 is a perspective view showing an example of an electronic apparatus comprising a mobile telephone; and

FIG. 21 is a perspective view showing an example of an electronic apparatus comprising a personal digital assistant.

### DESCRIPTION OF EXEMPLARY EMBODIMENTS

### A: FIRST EMBODIMENT

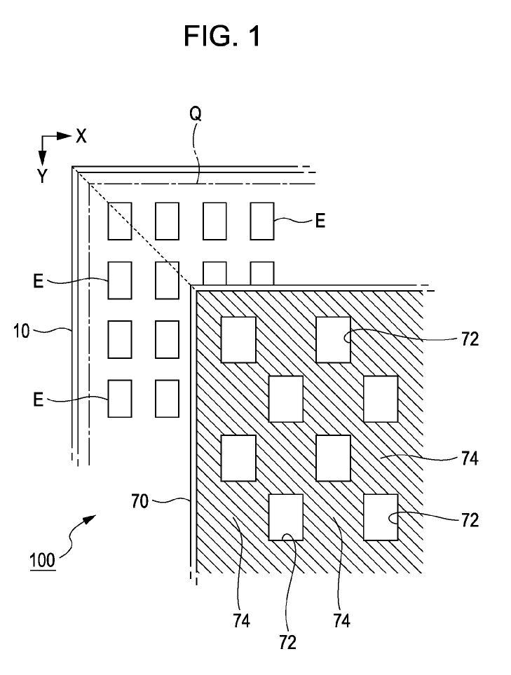

FIG. 1 is a plan view of a display device according to a first embodiment of the invention. As shown in FIG. 1, the display device 100 includes a display body 10 and a light separating body 70. The display body 10 is a liquid crystal display panel in which liquid crystal fills a predetermined gap between two substrates which face each other. The light separating body 70 is a plate-shaped member arranged at a viewing side (image output side) of the display body 10. An illumination device or backlight (not shown) for illuminating the display body 10 is provided on a rear surface side of the display body, which is opposite to the light separating body 70 with the display body 10 interposed in-between.

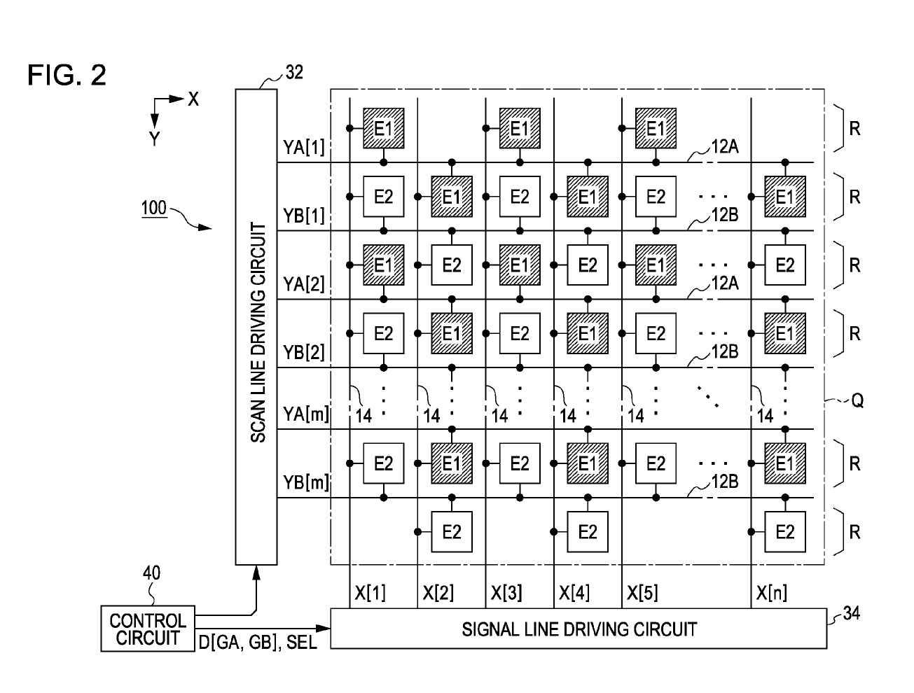

FIG. 2 is a block diagram showing the electrical configuration of the display body 10. As shown in FIGS. 1 and 2, the display body 10 includes an element unit Q in which a plurality of display elements E(E1, E2) are arranged on a plane. Each of the plurality of display elements E is a liquid crystal element in which liquid crystal is interposed between electrodes (a pixel electrode and a counter electrode) which face each other, with the gradation or transmissivity of light irradiated from the illumination device varying according to the voltage applied to the display elements E.

As shown in FIG. 2, in the element unit Q, 2m scan lines 12A and 12B, which are collectively referred to as scan lines 12, extend an X direction and n signal lines 14 are formed so as to extend in a Y direction which intersects the X direction, wherein m and n are natural numbers. A plurality of display elements E are arranged in a matrix in the X and Y direction in correspondence with the intersections between the scan lines 12 and the signal lines 14. That is, in the element unit Q, a plurality of sets (hereinafter, referred to as “element rows”) R of n display elements which are arranged in a plurality of parallel signal lines 14 in the X direction which extend in the Y direction. Transistors (not shown) are interposed between the display elements E and the signal lines 14, with gates connected to the scan lines 12.

The display body 10 displays a first image GA and a second image GB at the same time. The first image GA and the second image GB are, for example, stereoscopic images having parallax. As shown in FIG. 2, the plurality of display elements E in the element unit Q are divided into first display elements E1 used for the display of the first image GA and second display elements E2 used for the display of the second image GB. In FIG. 2 and the following drawings, the first display elements E1 are hatched in order to distinguish between the first display elements E1 and the second display elements E2.

As shown in FIG. 2, the first display elements E1 and the second display elements E2 are alternately arranged in the X and Y direction. That is, display elements E of odd-numbered columns of odd-numbered element rows R (m) and display elements E of even-numbered columns of even-numbered element rows R in the element unit Q are the first display elements E1, and display elements E of the even-numbered columns of the odd-numbered element rows R and the display elements E of the odd-numbered columns of the even-numbered element rows R in the element unit Q are the second display element E2.

The light separating body 70 of FIG. 1 is a plate-shaped optical body for separating the light emitted from the display body 10 into the display light which is emitted from the first display elements E1 which are used for the display of the first image GA and the display light which is emitted from the second display elements E2 which are used for the display of the second image GB. As shown in FIG. 1, the light separating body 70 of the present embodiment is a plate in which openings 72 and light-shielding portions 74 are alternately arranged in regions corresponding to the display elements E of the display body 10 in the X and Y directions.

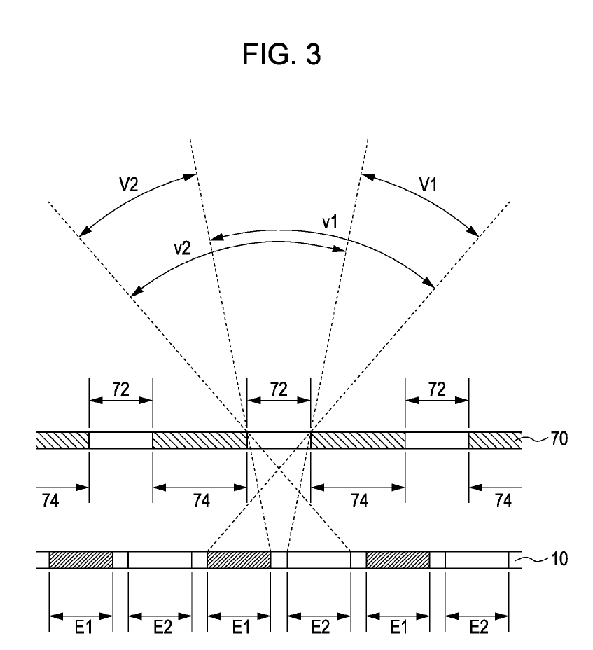

FIG. 3 is a cross-sectional view showing the relationship between the first display elements E1, the second display elements E2, and the light separating body 70. As shown in FIG. 3, the display light (emitted light) of the first display elements E1 is radiated in a range v1 via the openings 72 of the light separating body 70 and the display light of the second display elements E2 is radiated in a range v2 via the openings 72 of the light separating body 70. Accordingly, the display light of the first display elements E1 is viewed only in the range v1 and the display light of the second display elements E2 is viewed only in the range v2. For example, the display light radiated from the first display elements E1 in the range v1 reaches the left eye of the viewer and the display light radiated from the second display elements E2 in the range v2 reaches the right eye of the viewer.

As shown in FIG. 3, the first display elements E1 and the second display elements E2 are arranged in an alternating configuration. The openings 72 of the light separating body 70 are arranged so as to overlap the boundaries of the first display elements E1 and the second display elements E2 at positions formed between the first display elements E1 and the second display elements E2 in a predetermined direction. On the other hand, the light-shielding portions 74 of the light separating body 70 are arranged so as to overlap the boundaries formed between the second display elements E2 and the first display elements E1, at positions between the second display elements E2 and the first display elements E1 in the predetermined direction. The relationship of FIG. 3 is satisfied at any cross section in the X or Y direction.

As shown in FIG. 2, the 2m scan lines 12 are divided into m first scan lines 12A and m second scan lines 12B. The first scan lines 12A and the second scan lines 12B are arranged in an alternating configuration in the Y direction, so that the second scan lines 12B are positioned between adjacent first scan lines 12A. The first scan lines 12A are connected with n first display elements E1 which belong to two adjacent element rows R of the Y direction and are connected to the separate signal lines 14 at various points in the X direction. That is, the first display elements E1 of the odd-numbered columns of the odd-numbered element rows R and the first display elements E1 of the even-numbered columns of the even-numbered element rows R are commonly connected to the first scan lines 12A. The second scan lines 12B are connected with n second display elements E2 which belong to two adjacent element rows R of the Y direction and are connected to the separate signal lines 14. That is, the second display elements E2 of the even-numbered columns of the odd-numbered element rows R and the second display elements E2 of the odd-numbered columns of the even-numbered element rows R are commonly connected to the second scan lines 12B. Accordingly, only the plurality of first display elements E1 are connected to the first scan lines 12A and only the plurality of second display elements E2 are connected to the second scan lines 12B.

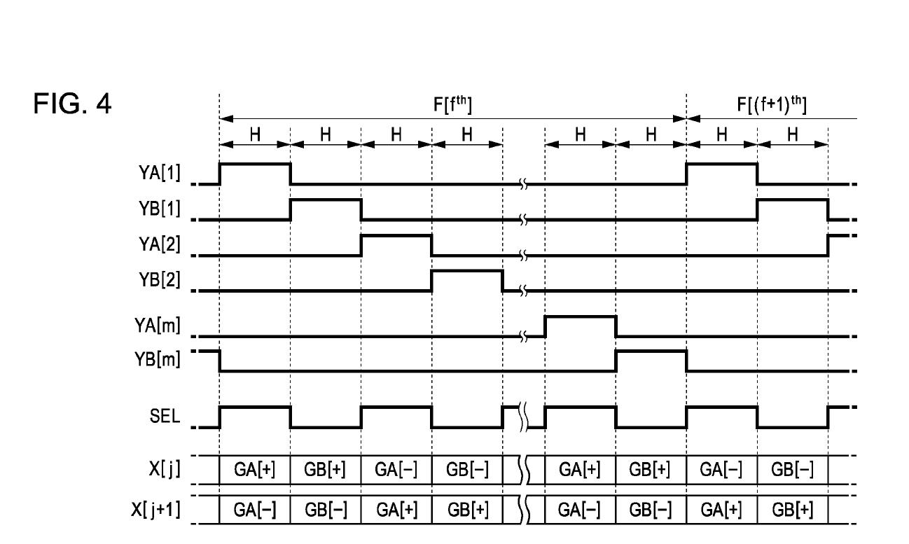

FIG. 4 is a timing chart explaining the operation of the display device 100. As shown in FIG. 4, a scan line driving circuit 32 of FIG. 2 sequentially selects the 2m scan lines 12 in a selection period H comprising a horizontal scan period in a unit period comprising a vertical scan period F by setting scan signals Y (YA[1] to YA[m] and YB[1] to YB[m]) output from the scan lines 12 to an active level in a predetermined order. The scan signals YA[1] to YA[m] are output to the first scan lines 12A and the scan lines YB[1] to YB[m] are output to the second scan lines 12B. In more detail, the scan line driving circuit 32 sequentially selects the 2m scan lines 12 in order of their arrangement in the Y direction. Since the first scan lines 12A and the second scan lines 12B are arranged alternately in the Y direction, the scan line driving circuit 32 alternately selects the first scan lines 12A and the second scan lines 12B in every selection period H, as shown in FIG. 4.

A control circuit 40 of FIG. 2 controls the scan line driving circuit 32 and a signal line driving circuit 34. For example, the control circuit 40 outputs a synchronization signal or a control signal to the scan line driving circuit 32 and the signal line driving circuit 34 and outputs gradation data D and a data selection signal SEL to the signal line driving circuit 34. The gradation data D specifies the gradation of the pixel of both the first image GA and the second image GB. As shown in FIG. 4, the data selection signal SEL is set to a high level in the selection period H where the first scan lines 12A are selected, or the selection period H in which any one of the scan signals YA[1] to YA[m] is in the active level. Conversely, the selection signal SEL is set to a low level in the selection period H where the second scan lines 12B are selected, or the selection period H in which any one of the scan signals YB[1] to YB[m] is in the active level.

The signal line driving circuit 34 of FIG. 2 outputs data voltages X[1] to X[n] specifying the applied voltages of the display elements E to n signal lines 14 in every selection period H in parallel. In the selection period H in which the scan line 12 of an i^{th} row is selected, where i=1 to 2m, the data voltage X[j] output to the signal line 14 of a j^{th} column, where j=1 to n, is set to a voltage value according to the gradation specified to the display element E of the j^{th} column of the i^{th} row.

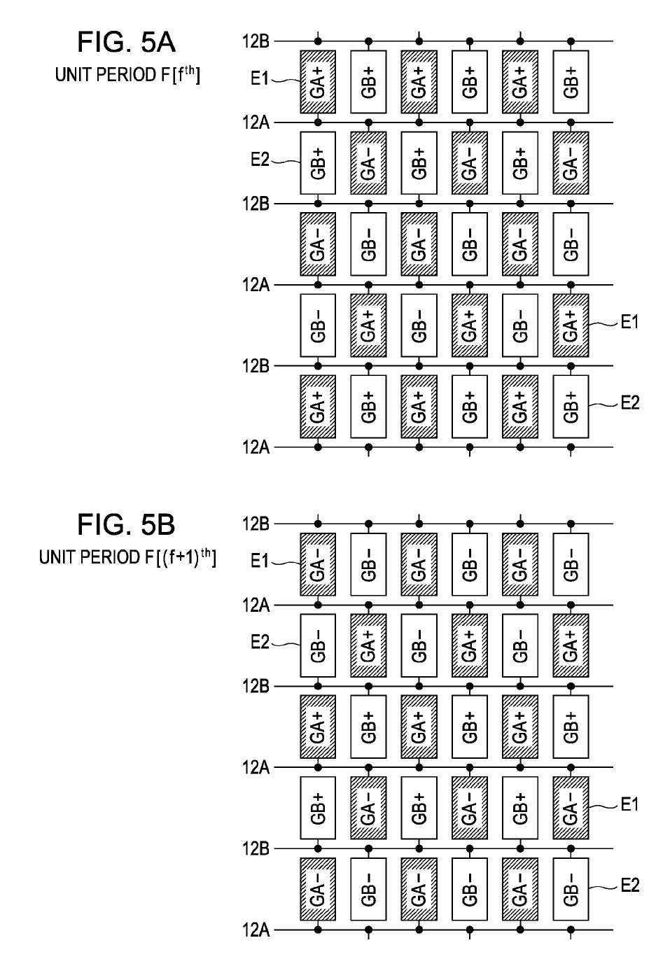

In FIG. 4, the data voltage X[j] supplied to the signal line 14 of the j^{th} column and data voltage X[j+1] supplied to the signal line 14 of the (j+1)^{th} column are shown. FIGS. 5A and 5B illustrate the contents of an image displayed in the element unit Q. The display of a f^{th} unit period F is shown in FIG. 5A and the display of a (f+1)^{th} unit period F is shown in FIG. 5B. As shown in FIG. 4, the signal line driving circuit 34 generates and outputs the data voltages X[1] to X[n] to the signal lines 14 according to the gradation data D of the first image GA in the selection period H where the data selection signal SEL is in the high level, corresponding to the selection of the first scan lines 12A. The signal line driving circuit 34 also generates and outputs the data voltages X[1] to X[n] to the signal lines 14 according to the gradation data D of the second image GB in the selection period H where the data selection signal SEL is in the low level, corresponding to the selection of the second scan lines 12B.

Since only the plurality of first display elements El are connected to the first scan lines 12A, the applied voltages of the n first display elements E1 connected to the first scan lines 12A are set according to the data voltages X[1] to X[n] in the selection period H in which the first scan lines 12A are selected. Similarly, the applied voltages of the n second display elements E2 connected to the second scan lines 12B are set according to the data voltage X[1] to X[n] in the selection period H in which the second scan lines 12B are selected. Accordingly, as shown in FIGS. 5A and 5B, the first image GA is displayed by the first display elements E1 and the second image GB is displayed by the second display elements E2.

As described above, in the present embodiment, since only the first display elements E1 are connected to the first scan lines 12A and only the second display elements E2 are connected to the second scan lines 12B, the data voltages X[1] to X[n] output to the signal lines 14 are generated from the gradation data D of the common images GA and GB in the selection period H. Accordingly, it is not necessary to use a complicated process or configuration to synthesize the gradation data D of the first image GA and the gradation data D of the second image GB in every selection period H.

In addition to the above-described operation, the signal line driving circuit 34 selects the polarities of the data voltages X[1] to X[n] with respect to a predetermined reference voltage (for example, the voltage of a counter electrode) such that the applied voltages of the display elements E are changed from either a positive polarity or a negative polarity to the opposite polarity in a predetermined period. In more detail, the signal line driving circuit 34 controls the data voltages X[1] to X[n] such that the polarities of the applied voltages of the display elements E satisfy the conditions described below. In FIG. 4, the polarities (+, −) of the data voltage X[j] and the data voltage X[j+1] are shown. Similarly, a sign “+” of FIG. 5 indicates that the applied voltages of the display elements E are the positive polarity and a sign “−” indicates that the applied voltages of the display elements E are the negative polarity.

As shown in FIG. 4, the signal line driving circuit 34 sets the data voltages X (X[j], X[j+1]) output to the adjacent signal lines 14 of the X direction in the selection period H to the opposite polarities. Accordingly, as shown in FIGS. 5A and 5B, the applied voltages are reversed in the first display elements E1 of the n first display elements E1 connected to the same first scan line 12A. Similarly, the polarities in the second display elements E2 of the n second display elements E2 connected to the same second scan line 12B are reversed.

As shown in FIG. 4, the signal line driving circuit 34 reverses the polarity of the data voltage X in the unit of two successive selection periods H (the selection period H in which the first scan lines 12A are selected and the selection period H in which the second scan lines 12B are selected). For example, the data voltage X[j] is set to the positive polarity in the two selection periods H in which the scan signal YA[1] and the scan signal YB[1] are in the high level and the data voltage X[j] is reversed to have negative polarity in the two selection periods H in which the scan signal YA[2] and the scan signal YB[2] are in the high level. Accordingly, as shown in FIG. 5, in the 2m display elements E connected to the same signal line 14, the polarity of the applied voltage is reversed in a unit of adjacent first display elements E1 and second display elements E2 in the Y direction.

As shown in FIG. 4, the signal line driving circuit 34 reverses the polarity of the data voltage X supplied to one display element E in every unit period F. Accordingly, the polarity of the applied voltage of each of the display elements E are reversed from the polarity shown in the f^{th} unit period F shown in FIG. 5A and the (f+1)^{th} unit period F shown in FIG. 5B.

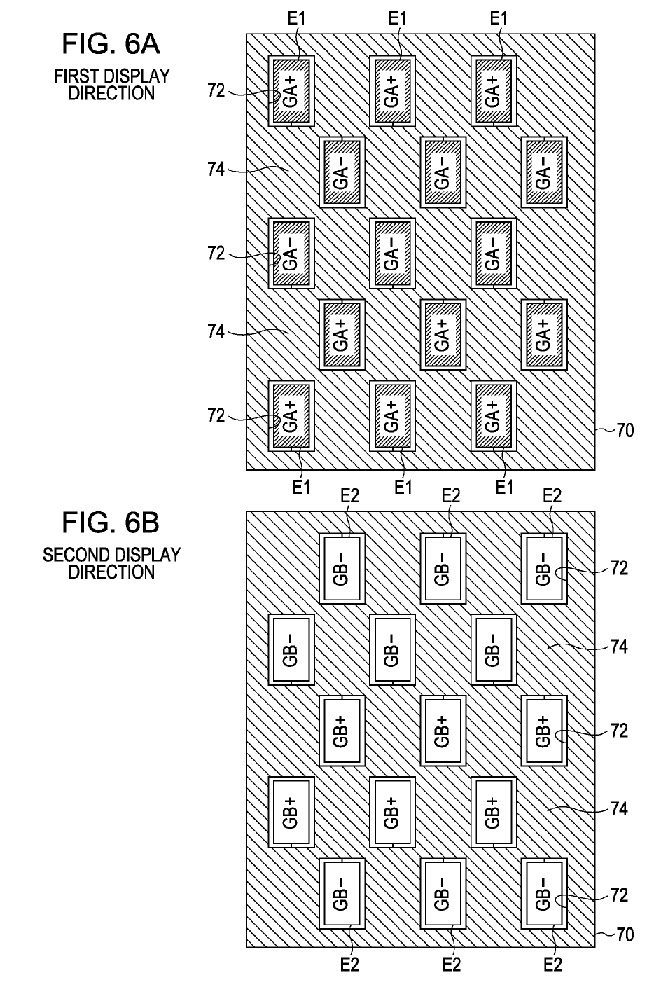

Next, FIGS. 6A and 6B illustrate an image output in a first display direction (FIG. 6A) and an image output in a second display direction (FIG. 6B) in the f^{th} unit period F. The first display direction and the second display direction are different with respect to the display device 100. For example, if the first image GA and the second image GB are stereoscopic images having parallax, the first display direction corresponds to the direction of the left eye of the viewer and the second display direction corresponds to the direction of the right eye of the viewer. As shown in FIG. 6A, the display light from the first display elements E1 are emitted in the first display direction such that the first image GA is output in the first display direction and, as shown in FIG. 6B, the display light from the second display elements E2 is emitted in the second display direction such that the second image GB is output in the second display direction. The same is true in the (f+1)^{th} unit period F.

Even when the same gradation is specified by the gradation data D, the actual gradations of the display elements E may be changed according to the polarities of the applied voltages. Accordingly, unlike the systems currently known in the art, wherein if the applied voltages of all the first display elements E1 (or all the second display elements E2) have the same polarity in the unit period F, a flicker may occur when the same gradation is specified in the plurality of unit periods F, in the present embodiment, since there are first display elements E1 with positive polarity and negative polarity in one unit period F, the difference in gradation according to the polarities of the applied voltages is averaged in the element unit Q and are unlikely to be recognized by the viewer.

### B: SECOND EMBODIMENT

Next, a second embodiment of the invention will be described. In the following embodiments, the same elements as the first embodiment in its operations or functions are denoted by the same reference numerals and the detailed description thereof will be omitted.

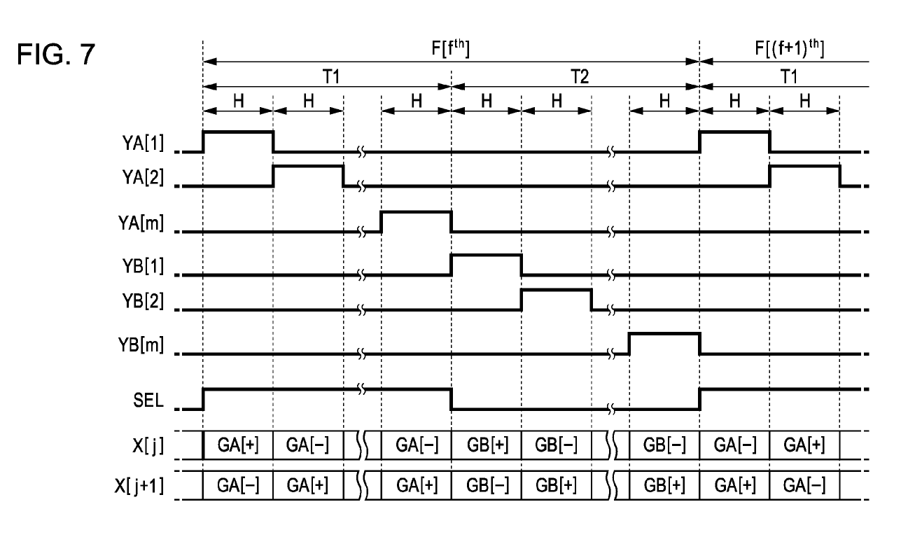

FIG. 7 is a timing chart showing the operation of the display device 100. As shown in FIG. 7, each of the plurality of unit periods F are divided into a first period T1, which starts at the beginning of each unit period F and extends a predetermined period of time, and a second period T2, which starts at the end of the first period T1 and extends until an end point of each unit period F. From the waveforms of the scan signal YA[1] to YA[m] and the scan signals YB[1] to YB[m] shown in FIG. 7, it can be seen that the scan line driving circuit 32 sequentially selects the m first scan lines 12A in the first period T1 and the m second scan lines 12B in the second period T2.

The data selection signal SEL is maintained in the high level in the first period T1 and in the low level in the second period T2. Accordingly, the signal line driving circuit 34 generates and outputs the data voltages X[1] to X[n] to the signal lines 14 according to the gradation data D of the first image GA in each selection period H of the first period T1 and generates and outputs the data voltages X[1] to X[n] to the signal lines 14 according to the gradation data D of the second image GB in each selection period H of the second period T2.

In the first period T1, the signal line driving circuit 34 sets the data voltages X (X[j], X[j+1]) output to the signal lines 14, which are adjacent in the X direction, to the opposite polarities, as described in the first embodiment. In addition, the signal line driving circuit 34 reverses the polarity of the data voltage X in every selection period H of the first period T1. Similarly, in the second period T2, the data voltages X (X[j], X[j+1]) output to the signal lines 14, which are adjacent in the X direction, are set to have opposite polarities and the polarity of the data voltage X is reversed in every selection period H.

Since the scan line driving circuit 32 and the signal line driving circuit 34 are operated as described above, in the whole unit period F, the voltages having the polarities shown in FIGS. 5A and 5B are applied to the first display elements E1 and the second display elements E2 so as to display the same images GA and GB as described in FIGS. 5A and 5B. Accordingly, the same operation and effect as the first embodiment can be obtained.

### C: THIRD EMBODIMENT

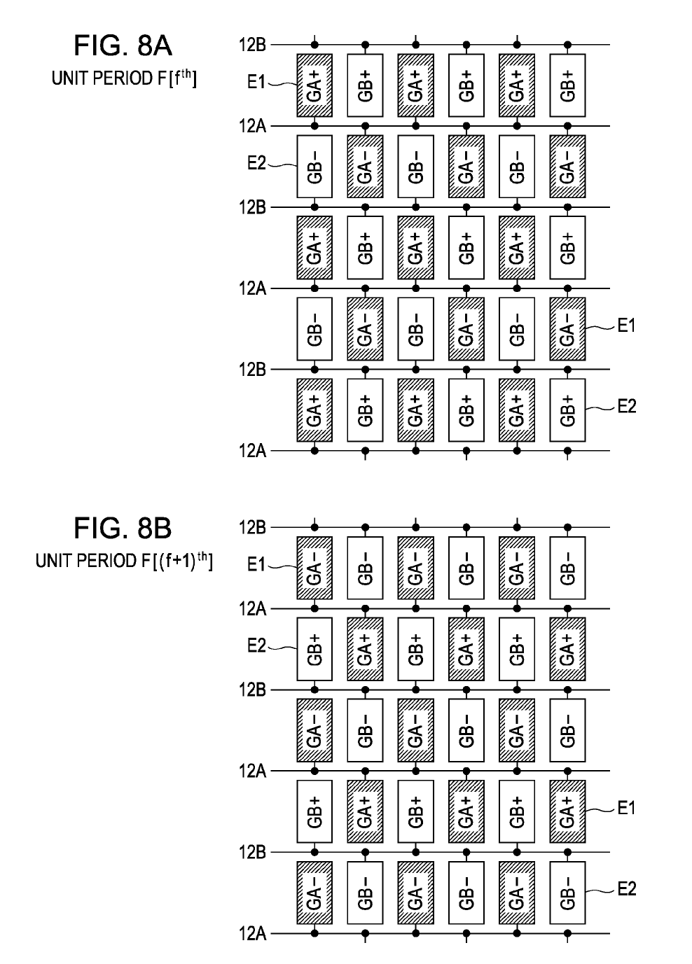

FIGS. 8A and 8B show the contents of the image displayed in the element unit Q. The scan line driving circuit 32 alternately selects the first scan lines 12A and the second scan lines 12B in the unit period F, similar to the first embodiment. As shown in FIGS. 8A and 8B, the signal line driving circuit 34 selects the polarity of the data voltage X in each unit period F such that the voltages applied to adjacent first display elements E1 and second display elements E2 in the Y direction have opposite polarities. The present embodiment is similar to the first embodiment in that the data voltages X (X[j], X[j+1]) output to the signal lines 14 which are adjacent in the X direction are set to have opposite polarities and the applied voltages of the display elements E are reversed in every unit period F.

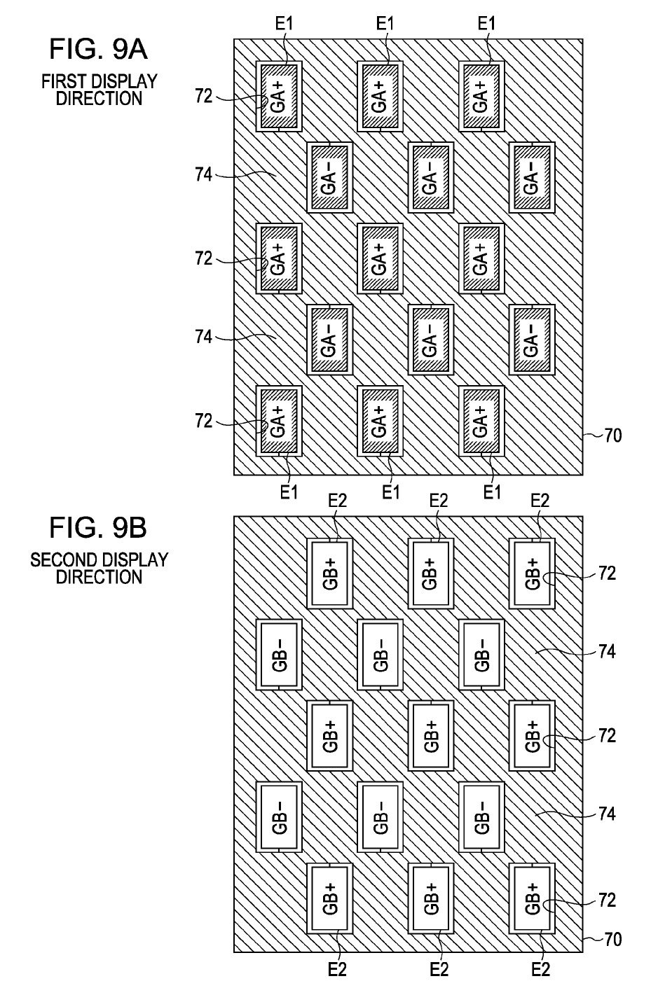

FIGS. 9A and 9B show an image output in the first display direction (FIG. 9A) and an image output in the second display direction (FIG. 9B) in the f^{th} unit period F. As shown in FIGS. 9A and 9B, the first display elements E1 and the second display elements E2 each include elements with both positive and negative polarity. Accordingly, similar to the first embodiment, the difference in gradation due to the polarities of the applied voltages is averaged in the element unit Q. In particular, in the present embodiment, as shown in FIGS. 9A and 9B, since the applied voltages of the first display elements E1 for displaying the first image GA are reversed in the unit of rows, the effect of averaging the difference in gradation of the first display elements E1 is improved over the first embodiment (FIGS. 5A-5B and 6A-6B) in which the applied voltages of the first display elements E1 are reversed in a unit comprised of two rows. The same is true in the second display elements E2.

As shown in FIGS. 8A and 8B, since the applied voltages of the display elements E in the element rows R are set to the same polarity, the difference in data voltage X between the first display elements E1 and the adjacent second display elements E2 in the X direction is reduced. Accordingly, the phenomenon in which the data voltage X supplied to the display elements E has an influence on the gradation of adjacent display elements E in the X direction, referred to as crosstalk, is reduced.

### D: FOURTH EMBODIMENT

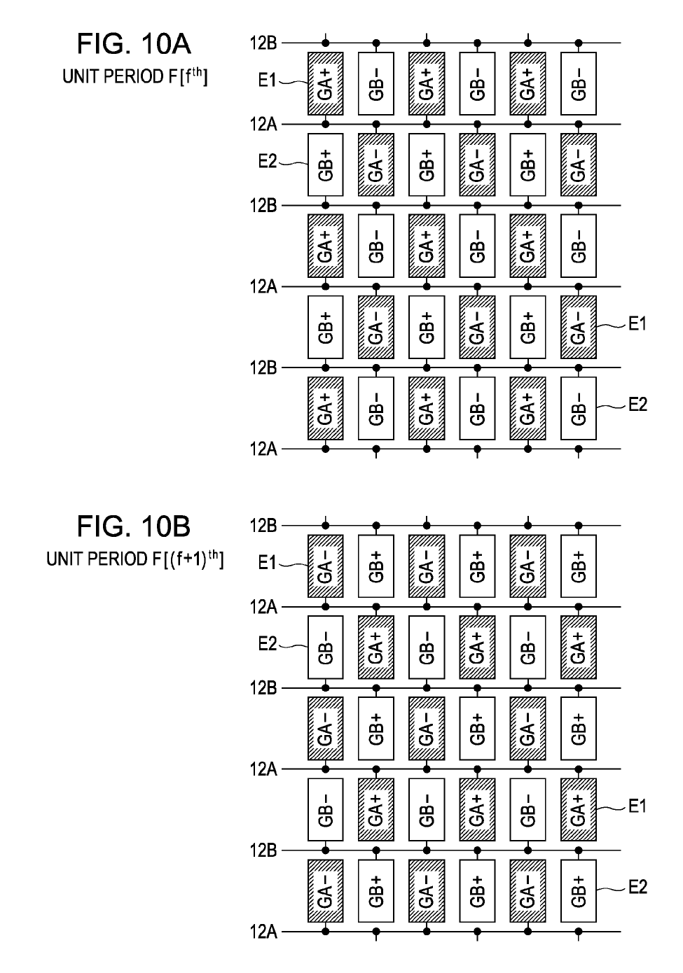

FIGS. 10A and 10B illustrate the contents of the image displayed in the element unit Q. The scan line driving circuit 32 alternately selects the first scan lines 12A and the second scan lines 12B in the unit period F, similar to the first embodiment. As shown in FIG. 10, the signal line driving circuit 34 selects the polarity of the data voltage X in each unit period F such that the voltages applied to the first display elements E1 and the adjacent second display elements E2 in the Y direction have the same polarity. The present embodiment is similar to the first embodiment in that the data voltages X (X[j], X[j+1]) output to adjacent signal lines 14 in the X direction are set to opposite polarities and the applied voltages of the display elements E are reversed in every unit period F.

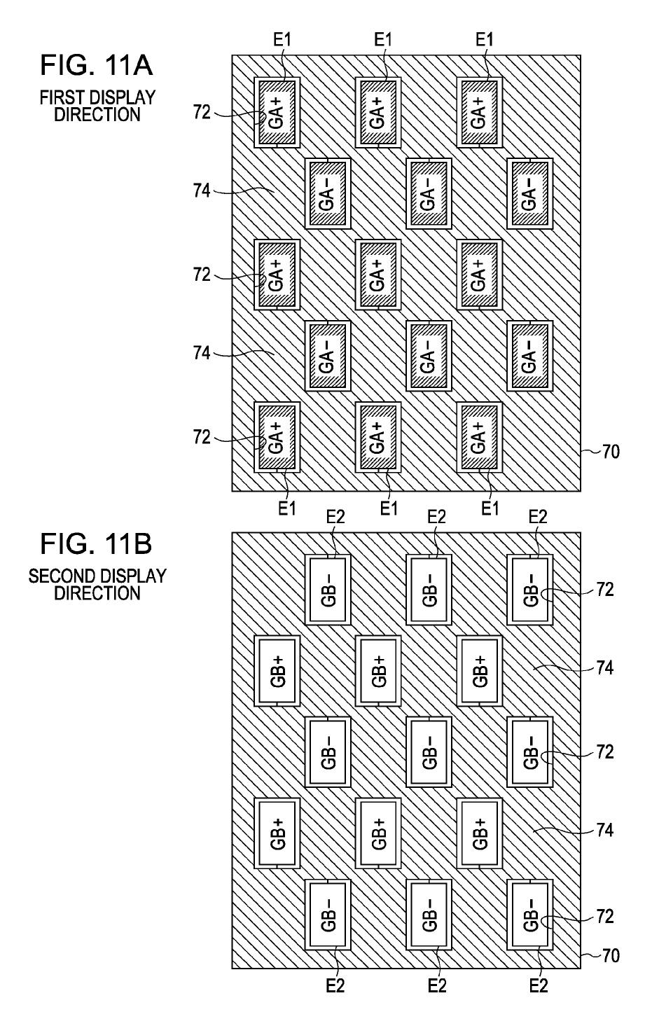

FIGS. 11A and 11B show an image output in the first display direction (FIG. 11A) and an image output in the second display direction (FIG. 11B) in the f^{th} unit period F. As shown in FIGS. 11A and 11B, the applied voltages of the first display elements E1 for displaying the first image GA and the applied voltages of the second display elements E2 for displaying the second image GB are reversed as units of rows, creating the same effect as in the third embodiment.

Since the applied voltages of the adjacent display elements E in the Y direction are set to have the same polarity, the difference in data voltage X between the first display elements E1 and the second display elements E2 which are adjacent in the Y direction is reduced. Accordingly, a phenomenon in which the data voltage X supplied to the display elements E has an influence on the gradation of adjacent display elements E in the Y direction, or crosstalk in the Y direction, is reduced. In addition, the power consumed in the signal line driving circuit 34 is less than in the configuration where the polarity of the data voltage X is reversed in the unit period F because the data voltage X output to one signal line 14 has the same polarity in the unit period F.

Although the first scan line 12A and the second scan line 12B are alternately selected in the unit period F in the third embodiment and the fourth embodiment, the polarities of the applied voltages of the display elements E are may be set similar to the third embodiment (FIGS. 8A and 8B) or the fourth embodiment (FIGS. 10A and 10b) in conjunction to the second embodiment, in which the first scan lines 12A and the second scan lines 12B are sequentially selected in the first and second period T1 and T2.

### E: FIFTH EMBODIMENT

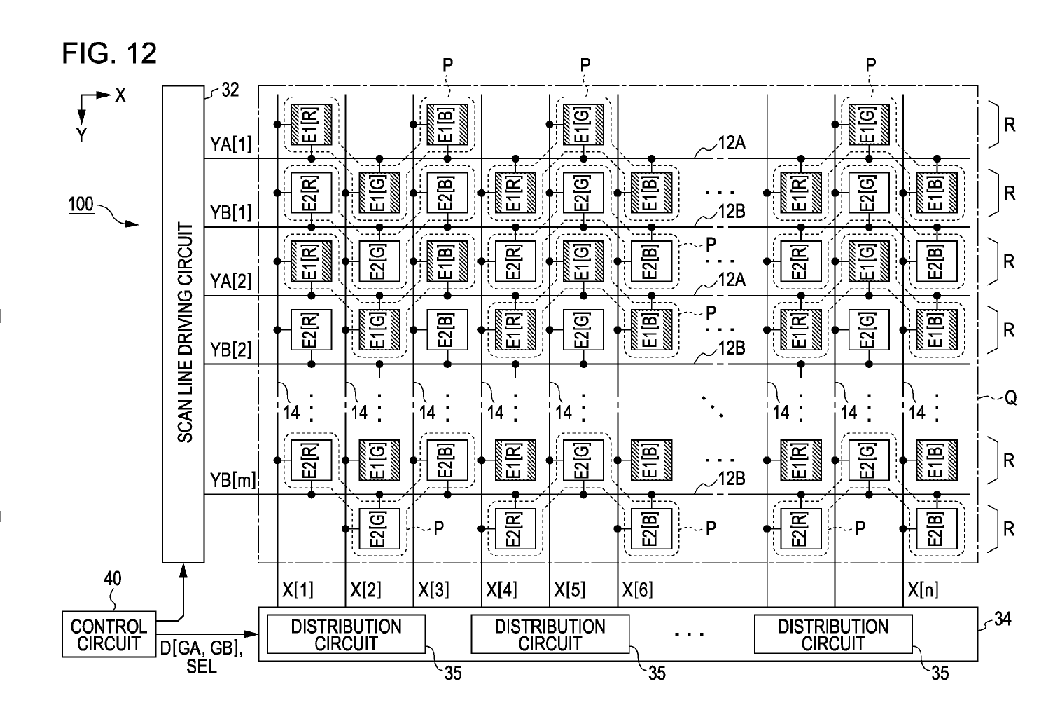

FIG. 12 is a block diagram showing the electrical configuration of the display device 100 according to a fifth embodiment of the invention. As shown in FIG. 12, each of the display elements E in the element unit Q corresponds to any one of a plurality of display colors (red (R), green (G) and blue (B)). That is, the display elements E of red emit colored light having a wavelength of red to a viewing side, the display elements E of green emit green-colored light, and the display elements E of blue emit blue-colored light. The display elements E of a (3k−2)^{th} column comprise red elements, the display elements E of a (3k−1)^{th} column comprise green elements, and the display elements E of a 3k^{th} column comprise blue elements, where k is a natural number. Accordingly, the 2m display elements E arranged as columns in the Y direction comprise elements of the same color, giving the display a stripe configuration. The arrangement of the display colors may be arbitrarily changed.

Similar to the first and second embodiments, the n first display elements E1 of two element rows R are connected to the m first scan lines 12A of the 2m scan lines 12 and the n second display elements E2 of two element rows R are connected to the m second scan lines 12B. As shown in FIG. 12, the n display elements E connected to the common scan lines 12 are divided into element groups P comprising a unit of three display elements E connected to three adjacent signal lines 14, and correspond to red, green, and blue display elements E. By controlling the gradations of the three display elements E in each of the element groups P, images of a plurality of colors are displayed in the element unit Q.

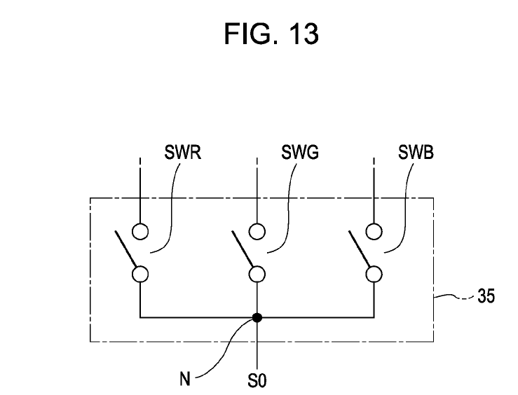

The signal line driving circuit 34 includes a plurality (n/3) of distribution circuits 35 arranged so as to correspond with every three adjacent signal lines 14 (in every element group P arranged in the X direction). As shown in FIG. 13, each of the distribution circuits 35 comprising a demultiplexer include an input point N and three switches SW (SWR, SWG and SWB). An original signal S0 is supplied to the input point N. The original signal S0 is a voltage signal of one system for specifying the gradations or applied voltages for the three display elements E belonging to one element group P in time division. Each of the distribution circuits 35 sequentially switches on the three switches SW (SWR, SWG and SWB) and distributes the original signal S0 to the three systems. The signal line driving circuit 34 generates and outputs the data voltage X of the three systems corresponding to one element group P to the signal lines 14 on the basis of the signals of the three systems distributed by the distribution circuits 35.

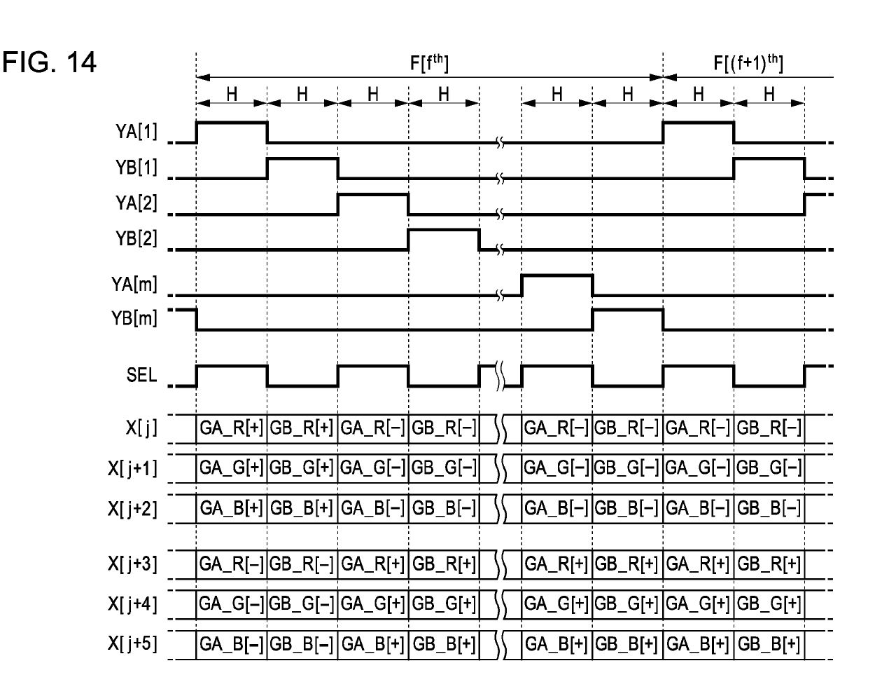

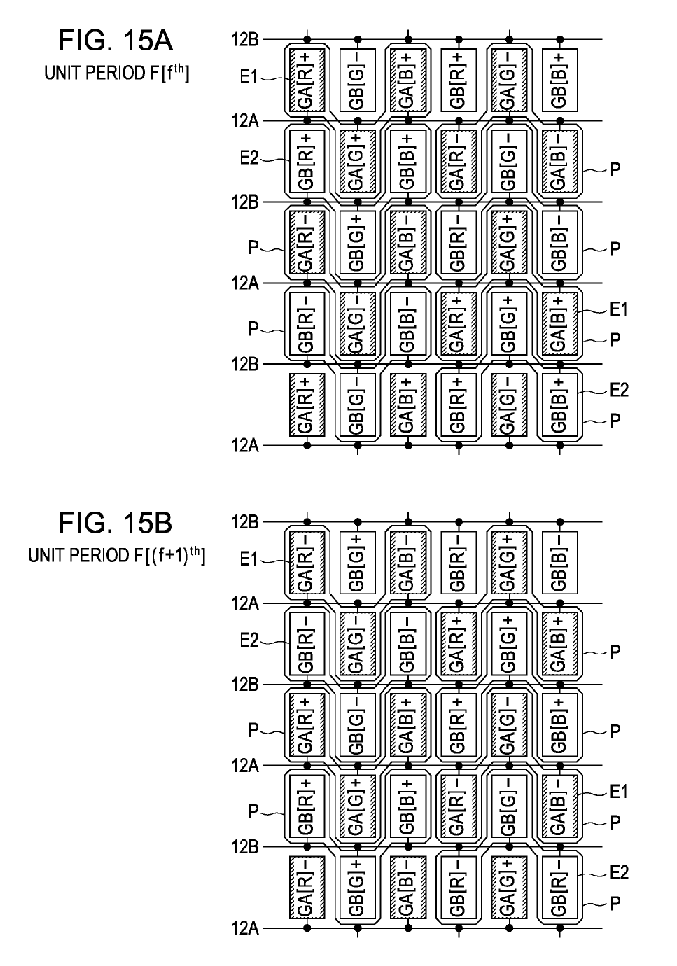

Next, FIG. 14 is a timing chart showing the operation of the display device 100. FIGS. 15A and 15B show the contents of the display of the display elements in the f^{th} and (f+1)^{th} unit periods F together with the polarities of the applied voltages. As shown in FIG. 14, the present embodiment is similar to the first embodiment in that the scan line driving circuit 32 sequentially selects the 2m scan lines 12 by alternately selecting the first scan lines 12A and the second scan lines 12B.

The signal line driving circuit 34 generates and outputs the data voltages X[1] to X[n] of n systems to the signal lines 14 in order to specify the gradations (applied voltages) of the n display elements E connected to the scan lines 12 according to the operations of the distribution circuits 35, in the selection period H in which the scan lines 12 of the i^{th} row are selected. A reference numeral “GA_R” of FIG. 14 indicates that the voltage value of the data voltage X is set to a voltage value corresponding to the gradation of the pixel of red (R) of the first image GA. Similarly, a reference numeral “GA_G” denotes a voltage value corresponding to the gradation of the pixel of green and a reference numeral “GA_B” denotes a voltage value corresponding to the gradation of the pixel of blue. In the present embodiment, the polarities of the data voltages X[1] to X[n] are set such that the polarities of the applied voltages of the display elements E the conditions described below. As shown in FIGS. 15A and 15B, the polarities of the applied voltages of the display elements E are reversed in every unit period F, similar to the first embodiment.

As shown in FIG. 14, the signal line driving circuit 34 sets the data voltage X output to the three signal lines 14 comprising one element group P to the same polarity. For example, the data voltages X[j] to X[j+2] supplied to the three signal lines 14 from the j^{th} columns to the (j+2)^{th} column comprising one element group P have the same polarity. Accordingly, as shown in FIGS. 15A and 15B, the applied voltages of the three display elements E (red, green and blue) belonging to the same element group P have the same polarity.

As shown in FIG. 14, the signal line driving circuit 34 reverses the polarity of the data voltage X in the unit of three signal lines 14 comprising one element group P. For example, as shown in FIG. 14, the data voltages X[j] to X[j+2] supplied to the three signal lines 14 from the j^{th} columns to the (j+2)^{th} column comprising one element group P and the data voltages X[j+3] to X[j=5] supplied to the three signal lines 14 from the (j+3)^{th} column to the (j+5)^{th} column comprising another element group P have the opposite polarities. Accordingly, the applied voltages of the display elements E of adjacent element groups P in the X direction which are connected to the same scan line 12 have the opposite polarities.

Similar to the first embodiment, the signal line driving circuit 34 reverses the polarity of the data voltage X in two successive selection periods H, comprising the selection period H in which the first scan lines 12A are selected and the selection period H in which the second scan lines 12B are selected. For example, as shown in FIG. 14, the data voltage X[j] is set to have a positive polarity in the two selection periods H in which the scan signal YA[1] and the scan signal YB[1] are in the high level and the data voltage X[j] is set to have a negative polarity in the two selection periods H in which the scan signal YA[2] and the scan signal YB[2] are in the high level. Accordingly, as shown in FIGS. 15A and 15B, in the 2m display elements E connected to the same signal line 14, the polarity of the applied voltage is reversed between adjacent first display elements E1 and second display elements E2 in the Y direction.

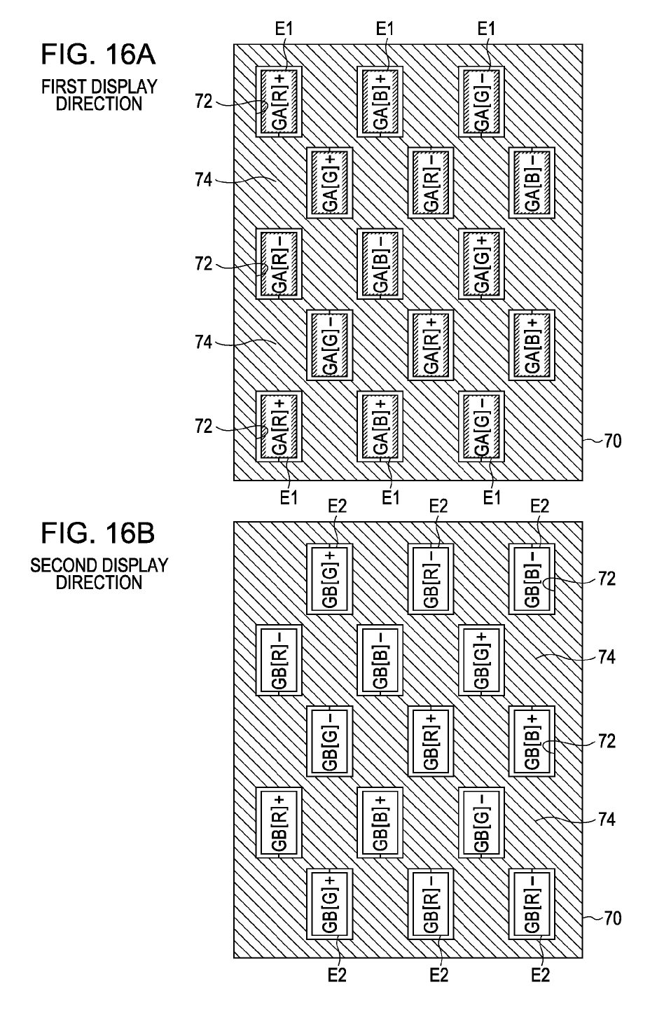

FIGS. 16A and 16B show an image output in a first display direction (FIG. 16A) and an image output in a second display direction (FIG. 16B) in the f^{th} unit period F. As shown in FIG. 16A, the first image G1 is comprised first display elements E1 of both positive and negative polarities. Similarly, the second image GB is comprised of second display elements E2 of both positive and negative polarities. Advantageously, the difference in gradation according to the polarities of the applied voltages is averaged in the element unit Q and is unlikely to be recognized by the viewer.

The relationship (balance) between the gradations of the display elements E in the element group P is accurately set, compared with the case where the polarities of the applied voltages of the display elements E are different in the element group P, because the applied voltages of the three display elements E belonging to one element group P are set to have the same polarity. Accordingly, it is possible to improve color reproduction of the image. Also, the voltage of the input point N is maintained at the same polarity in the period in which the distribution circuits 35 distribute the original signal S0 to three systems because the applied voltages of the three display elements E belonging to one element group P have the same polarity. Accordingly, it is possible to suppress the variation in the voltage of the input point N, and reduce the power consumption of the signal line driving circuit 34, as compared to the case where the polarities of the applied voltages of the display elements E are different when the polarities of the original signal S0 are changed in the period in which the original signal S0 is distributed.

The applied voltages of the first display elements E1 and adjacent second display elements E2 in the Y direction are set to have the same polarity. Accordingly, it is possible to suppress the variation in the voltage value of the data voltage X or the number of times that the polarity of the data voltage X has to be reversed, as compared with the configuration in which the polarities of the applied voltages of all adjacent display elements E in the Y direction are reversed. Accordingly, it is possible to reduce the power consumption of the signal line driving circuit 34. If any one of the first image GA and the second image GB is a black image and the other thereof is a white image, since the difference between the applied voltages of the first display elements E1 and the second display elements E2 is increased, it is possible to suppress the number of times that the polarity of the data voltage X is reversed and the variation in the voltage value.

### F: SIXTH EMBODIMENT

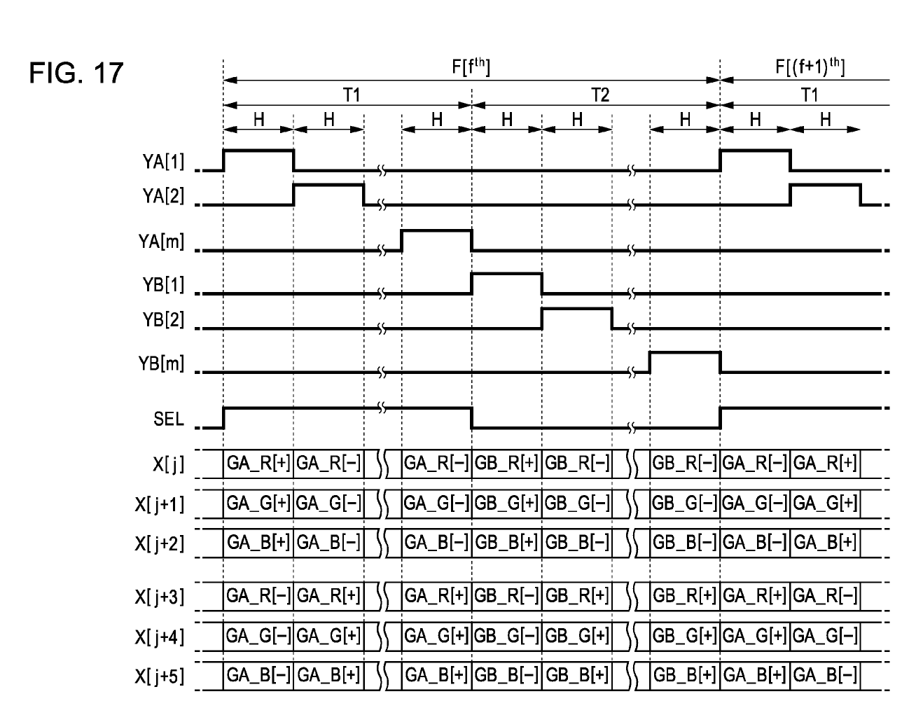

FIG. 17 is a timing chart showing the operation of the display device 100 according to a sixth embodiment of the invention. Similar to the second embodiment, the scan line driving circuit 32 sequentially selects the m first scan lines 12A in every selection period H of the first period T1 of each unit period and sequentially selects the m second scan lines 12B in every selection period H in the second period T2. The display elements E of the element unit Q are divided into the element groups P according to the display colors, similar to the fifth embodiment.

In the first period T1 and the second period T2, the signal line driving circuit 34 reverses the polarity of the data voltage X in the unit of three adjacent signal lines 14 the X direction in correspondence with one element group P, similar to the fifth embodiment. In addition, the signal line driving circuit 34 reverses the polarity of the data voltage X in every selection period H of the first period T1 and reverses the polarity of the data voltage X in every selection period H of the second period T2.

Since the scan line driving circuit 32 and the signal line driving circuit 34 are operated as described above, in the whole unit period F, the voltages having the polarities shown in FIGS. 15A and 15B are supplied to the first display elements E1 and the second display elements E2 such that the same images (GA and GB) as shown in FIGS. 15A and 15B are displayed. Accordingly, the same effect as the fifth embodiment is obtained.

### G: MODIFIED EXAMPLES

The above-described embodiments are variously modified. The modified examples are described as follows. At least two of the following examples may be combined.

### (1) Modified Example 1

The contents of the first image GA and the second image GB are not limited to the stereoscopic images. Even when separate images are provided to a plurality of viewers located at different directions with respect to the display device 100, the display device 100 according to any one of the above-described embodiments is suitably employed. For example, if the display device 100 is used in a car navigation system, various types of moving images provided to a viewer sitting in a passenger seat are displayed in the first display elements E1 as the first image GA, while images of road guidance are provided to a driver in the second display elements E2 as the second image GB.

### (2) Modified Example 2

Although the unit period F is shown to comprise one first period T1 and one second period T2 of equal duration in the second embodiment and the sixth embodiment, the lengths of first period T1 and second period T2 in the unit period F may be arbitrarily changed. For example, according to the configuration in which a plurality of first periods T1 and one second period T2 are set in the unit period F, the first image GA displayed in the first display elements E1 in the first period T1 is updated more quickly using shorter periods than that of the second image GB. Accordingly, for example, when a moving image having a large image variation is selected as the first image GA and a moving image having a small image variation or a still image is selected as the second image GB, the first image GA is displayed such that a subject is smoothly changed. In addition, the speed of the operation of the scan line driving circuit 32 or the signal line driving circuit 34 is reduced compared with the configuration in which the second image GB is updated at the same frequency as the first image GA.

In the configuration where the first period T1 in which the first scan lines 12A are selected and the second period T2 in which the second scan lines 12B are selected are separately set, as described in the second or the sixth embodiment, the number of scan lines 12 selected by the scan line driving circuit 32 may be changed. For example, in the configuration in which only the first scan lines 12A from the first row to the m/2^{th} row of the m first scan lines 12A are selected in the first period T1 and the m second scan lines 12B are selected in the second period T2, the first image GA displayed in the upper half of the element unit Q and the second image GB displayed in the whole element unit Q can be output in different directions.

### (3) Modified Example 3

The configuration used to separate the display light of the first display elements E1 and the display light of the second display elements E2 in different directions is arbitrary. For example, the display light may be separated using an optical body such as a lenticular lens. In the above-described embodiment, a configuration wherein the light separating body 70 is arranged between the display body 10 and the illumination device of the rear side is preferable. Using this configuration, the light emitted from the illumination device comprising the first display elements E1 passes through the openings 72 of the light separating body 70 and travels in the first display direction, and the light from the illumination device comprising the second display elements E2 passes through the openings 72 of the light separating body 70 and travels in the second display direction.

### (4) Modified Example 4

Although one scan line driving circuit 32 selects the m first scan lines 12A and the m second scan lines 12B in the above-described embodiment, a scan line driving circuit 32 for selecting the first scan lines 12A and a separate scan line driving circuit 32 for selecting the second scan lines 12B may be used.

### (5) Modified Example 5

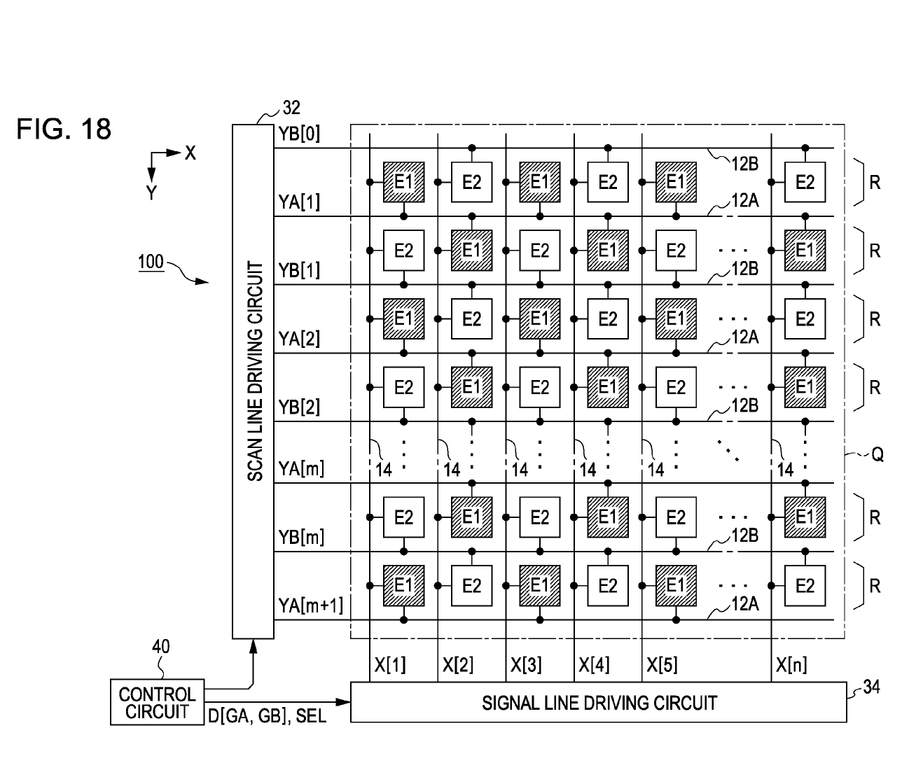

Although the uppermost element row R is configured to have only n/2 first display elements E1, while the lowermost element row R is configured by only n/2 second display elements E2 in the above-described embodiments, as shown in FIG. 18, the uppermost and lowermost element row R, may be comprised of an alternating configuration of first display elements E1 and second display elements E2 similar to the other element rows R.

### (6) Modified Example 6

Although the signal line driving circuit 34 acquires the gradation data D of all the pixels of the first image GA and the second image GB from the control circuit 40 and generates the data voltages X[1] to X[n] according to the data selection signal SEL in the above-described embodiments, a configuration may be used wherein only the gradation data D corresponding to the pixels corresponding to the first display elements E1 of the first image GA and the second display elements E2 of the second image GB may be supplied from the control circuit 40 to the signal line driving circuit 34.

### (7) Modified Example 7

The liquid crystal element is only one example of the display element capable of performing aspects of the invention. The display element employed in the configuration wherein only the first display elements E1 are connected to the first scan lines 12A and only the second display elements E2 are connected to the second scan lines 12B may also be used in a self-emission type element, a non-emission type element for changing the transmissivity of external light, a current driving type element which is driven by the supply of current, or a voltage driving type element which is driven by the supply of a potential or voltage. For example, the invention is applicable to a display device using various display elements such as an organic electroluminescence (EL) element, an inorganic EL element, a field-emission (FE) element, a surface conduction electron emitter (SE) element, a ballistic electron emitting (BS) element, a light emitting diode (LED) element, an electromigration element, and an electrochromic element. That is, the display element may be any optical element (pixel) in which the gradation (optical characteristic such as transmissivity or luminance) may be changed according to the electrical operation, such as the supply of the current or the supply of the voltage or potential. A configuration where the polarity of the applied voltage of the display element can be reversed as in the above-described embodiment is preferably used as the display element when deterioration of display characteristics may be caused due to the continuous application of a DC component.

### H: APPLICATION EXAMPLES

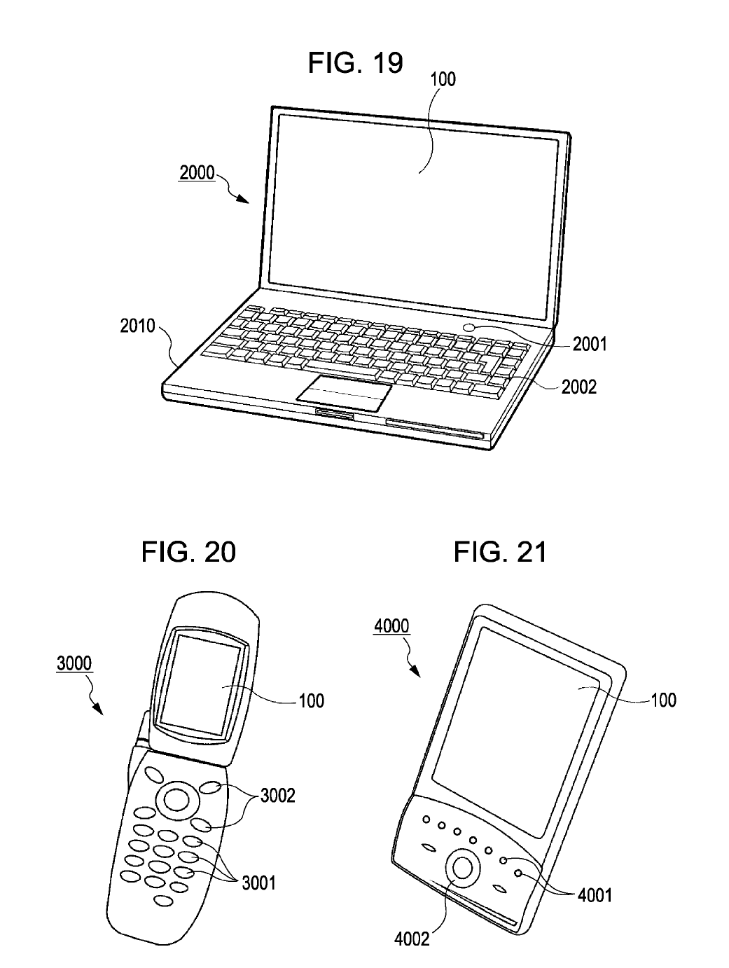

Next, an electronic apparatus using the display device 100 according to the invention will be described. FIGS. 19 to 21 show various electronic apparatuses capable of using the display device 100 according to one of the above-described embodiments.

FIG. 19 is a perspective view showing the configuration of a mobile personal computer using the display device 100 described herein. The personal computer 2000 includes the display device 100 for displaying various types of images and a main body 2010 including a power switch 2001 and a keyboard 2002.

FIG. 20 is a perspective view showing the configuration of a mobile telephone using the display device 100 described herein. The mobile telephone 3000 includes a plurality of operation buttons 3001, a scroll button 3002, and the display device 100 for displaying various types of images. By operating the scroll button 3002, the screen displayed on the display device 100 is scrolled.

FIG. 21 is a perspective view showing the configuration of a personal digital assistant (PDA) using the display device 100 described herein. The PDA 4000 includes a plurality of operation buttons 4001, a power switch 4002 and the display device 100 for displaying various types of images. By operating the power switch 4002, a variety of information such as an address book or a date book is displayed on the display device 100.

In addition to the apparatuses described in FIGS. 19 to 21, the invention may be used in a variety of other devices including a digital still camera, a television set, a video camera, a car navigation system, a pager, an electronic organizer, an electronic paper, an electronic calculator, a word processor, a workstation, a videophone, a POS terminal, a printer, a scanner, a copier, a video player and a touch-panel-equipped device.

What is claimed is:

1. A display device comprising:
a plurality of scan lines extending in a first direction;
a plurality of signal lines extending in a second direction which intersects the plurality of scan lines extending in the first direction; and
an element unit including a plurality of element rows comprised of a plurality of display elements corresponding to the plurality of scan lines extending in the first direction, the plurality of element rows being arranged parallel to the second direction,
wherein each of the plurality of element rows includes a plurality of first display elements and a plurality of second display elements visible from different directions, and
wherein the plurality of scan lines include:
a first scan line connected to at least two first display elements of at least two different element rows which correspond to separate signal lines; and
a second scan line connected to at least two second display elements of at least two different element rows which correspond to separate signal lines.

2. The display device according to claim 1, further comprising:
a light separating body comprised of alternately arranged openings and light-shielding portions in the first and second direction,
wherein the first display elements and the second display elements are arranged in an alternating configuration in the first and second direction, such that the display light of the first and second display elements pass through the openings of the light separating body in different directions.

3. The display device according to claim 2, wherein the applied voltages of the plurality of display elements are set such that the polarities of the applied voltages of the display elements have the opposite polarity than the adjacent display elements corresponding to the adjacent signal lines which are connected to the same scan line, such that a display unit comprised of a first display element and adjacent second display element in the second direction have the opposite polarities of an adjacent display unit in the second direction.

4. The display device according to claim 2, wherein the applied voltages of the plurality of display elements are set such that the polarities of the applied voltages of the display elements corresponding to the adjacent signal lines which are connected to the same scan line, such that first display elements have opposite polarities as the adjacent second display elements in the second direction.

5. The display device according to claim 2, wherein the applied voltages of the plurality of display elements are set such that the polarities of the applied voltages of the display elements corresponding to the adjacent signal lines which are connected to the same scan line, such that the first display elements have the same polarities as the adjacent second display elements in the second direction.

6. The display device according to claim 2, wherein:
each of the plurality of display elements corresponds to a display color from a plurality of display colors;
the applied voltages of the plurality of display elements are set such that the polarities of the applied voltages of the display elements in each of a plurality of element groups comprised of a group of a predetermined number of display elements corresponding to the display colors have the same polarity;
the polarity of the display elements of a element group are opposite to the polarity of an adjacent element group in the first direction which is connected to the same scan line; and
the polarity of a display unit comprised of a first display element and a second display element is opposite to the polarity of an adjacent display unit in the second direction.

7. The display device according to claim 3, wherein the driving circuit comprises:
a scan line driving circuit which alternately drives the plurality of first scan lines and the plurality of second scan lines in every selection period in order according to the second direction; and
a signal line driving circuit which outputs data voltages for assigning the applied voltages of the display elements to the signal lines in every selection period.

8. The display device according to claim 3, wherein the driving circuit includes:
a scan line driving circuit which sequentially drives the plurality scan lines in a plurality of selection periods comprised of first and second periods, wherein the second period follows the first period, and the scan line driving circuit sequentially drives the plurality of first scan lines in the first periods and the plurality of second scan lines in the second periods; and
a signal line driving circuit which outputs data voltages for assigning the applied voltages of the display elements to the signal lines in every selection period.

9. The display device according to claim 6, wherein the driving circuit comprises:
a scan line driving circuit which sequentially drives the plurality of scan lines; and
a signal line driving circuit which outputs data voltages for assigning the applied voltages of the display elements to the signal lines in each selection period,
wherein the signal line driving circuit includes a plurality of distribution circuits corresponding to the element groups arranged in the first direction and the distribution circuits distribute an original signal for assigning the applied voltages of the plurality of display elements in the element groups in time division to a plurality of systems in order to generate the data voltages.

10. An electronic apparatus comprising the display device according to claim 1.

11. A method of driving a display device including a plurality of scan lines extending in a first direction, a plurality of signal lines extending in a second direction intersecting the first direction, an element unit including a plurality of element rows comprised of a plurality of display elements arranged in the first direction which correspond to the plurality of signal lines, the plurality of element rows being arranged parallel to the second direction, and a light separating body comprised of an alternating arrangement of openings and light-shielding portions in the first and second direction which correspond to a plurality of first and second display elements visible from different directions, the method comprising:
connecting at least two of the first display elements belonging to at least two different element rows which correspond to separate signal lines to a first scan line;
connecting at least two of the second display elements belonging to at least two different element rows which correspond to separate signal lines to a second scan line; and
applying a voltage to the plurality of display elements so that the polarities of the adjacent display elements in the second direction which are connected to the same scan line are opposite and such that the polarity of adjacent display units comprised of an first display element and an adjacent second display element are opposite.

12. The method according to claim 11, wherein:
the plurality of first scan lines and the plurality of second scan lines are alternately driven in a plurality of selection periods according to the order of first and second scan lines the second direction, and
data voltages for specifying the applied voltages of the display elements are output to the signal lines in each selection period.

13. The method according to claim 11, wherein:
the plurality of scan lines are sequentially driven in a plurality of selection periods comprising a first period and second period following the first period;
the first scan lines are driven in the first period and the plurality of second scan lines are sequentially driven in the second period; and
data voltages for assigning the applied voltages of the display elements are output to the signal lines in every selection period.

14. A method of driving a display device including a plurality of scan lines extending in a first direction, a plurality of signal lines extending in a second direction intersecting the first direction, an element unit including a plurality of element rows comprised of a plurality of display elements arranged in the first direction which correspond to the plurality of signal lines, the plurality of element rows being arranged parallel to the second direction, and a light separating body comprised of an alternating arrangement of openings and light-shielding portions in the first and second direction which correspond to a plurality of first and second display elements which emit light in different directions, the method comprising:
connecting at least two of the first display elements belonging to at least two element rows which correspond to separate signal lines to a plurality of first scan lines;
connecting at least two of the second display elements belonging to at least two element rows which correspond to separate signal lines to a plurality of second scan lines; and
applying a voltage to the plurality of element groups comprised of a group of a predetermined number of display elements corresponding to the display colors which have the same polarity, so that the polarity of the display elements of a element group are opposite to the polarity of an adjacent element group in the first direction which is connected to the same scan line, and such that the polarity of a display unit comprised of a first display element and a second display element is opposite to the polarity of an adjacent display unit in the second direction.

15. The method according to claim 14, further comprising:
alternately driving the plurality of first scan lines and the plurality of second scan lines in a plurality of selection periods according to the order of first and second scan lines the second direction; and
outputting data voltages for specifying the applied voltages of the display elements to the signal lines in each selection period.

16. The method according to claim 14, further comprising:
sequentially driving the plurality of scan lines in a plurality of selection periods comprising a first period and second period following the first period, such that the first scan lines are driven in the first period and the plurality of second scan lines are sequentially driven in the second period; and
outputting the data voltages which assign the applied voltages of the display elements to the signal lines in every selection period.
